(19) United States
(12) Patent Application Publication
(10) Pub. No.: US 2018/0060632 A1
(43) Pub. Date: Mar. 1, 2018

(54) ELECTRONIC DEVICE INCLUDING FINGER BIOMETRIC SENSOR BASED DISPLAY POWER MODE SWITCHING AND RELATED METHODS

(71) Applicant: Apple Inc., Cupertino, CA (US)

(72) Inventors: Brian H. KNABENSHUE, Pleasanton, CA (US); Giovanni GOZZINI, Berkeley, CA (US)

(21) Appl. No.: 15/247,059

(22) Filed: Aug. 25, 2016

(51) Int. Cl. G06K 9/00; G06F 1/32; G06F 1/16

(52) U.S. Cl. CPC G06K 9/0002; G06F 1/3265; G06F 1/1626; G06F 1/1607; G06K 9/00087

(57) ABSTRACT

An electronic device may include a housing, a display carried by the housing and switchable between a power saving mode and an operating power mode, and a finger biometric sensor carried by the housing and configured to sense an image of an object adjacent thereto. The electronic device may also include a device cover carried by the housing and configured to be movable between an open position exposing the finger biometric sensor and a closed position covering the finger biometric sensor. The device cover may include a cover panel and an electrically conductive member carried by the cover panel adjacent the finger biometric sensor when in the closed position. A controller may be coupled to the finger biometric sensor and configured to determine when the electrically conductive member is adjacent the finger biometric sensor, and selectively switch the display between the power saving mode and the operating power mode based thereon.

### TECHNICAL FIELD

The present invention relates to the field of electronics, and, more particularly, to the field of finger biometric sensors.

### BACKGROUND

Fingerprint sensing and matching is a reliable and widely used technique for personal identification or verification. In particular, a common approach to fingerprint identification involves scanning a sample fingerprint or an image thereof and storing the image and/or unique characteristics of the fingerprint image. The characteristics of a sample fingerprint may be compared to information for reference fingerprints already in a database to determine proper identification of a person, such as for verification purposes.

A fingerprint sensor may be particularly advantageous for verification and/or authentication in an electronic device, and more particularly, a portable device, for example. Such a fingerprint sensor may be carried by the housing of a portable electronic device, for example, and may be sized to sense a fingerprint from a single-finger.

Where a fingerprint sensor is integrated into an electronic device or host device, for example, as noted above, it may be desirable to more quickly perform authentication, particularly while performing another task or an application on the electronic device. In other words, in some instances it may be undesirable to have a user perform an authentication in a separate authentication step, for example switching between tasks to perform the authentication. It may also be desirable for a fingerprint sensor to perform other functions beyond authentication.

### SUMMARY

An electronic device may include a housing, a display carried by the housing and switchable between a power savings mode and an operating power mode, and a finger biometric sensor carried by the housing and configured to sense an image of an object adjacent thereto. The electronic device may also include a device cover carried by the housing and configured to be movable between an open position exposing the finger biometric sensor and a closed position covering the finger biometric sensor. The device cover may include a cover panel and an electrically conductive member carried by the cover panel adjacent the finger biometric sensor when in the closed position. A controller may be coupled to the finger biometric sensor and configured to determine when the electrically conductive member is adjacent the finger biometric sensor, and selectively switch the display between a power saving mode and an operating power mode based thereon.

The controller may be configured to determine when the electrically conductive member is adjacent the finger biometric sensor based upon a frequency change detection. The electrically conductive member may have a pattern associated therewith, and the controller may be configured to enter the power saving mode based upon recognizing the pattern, for example.

The pattern may include a plurality of transverse elements. The electrically conductive member may be electrically floating, for example.

The controller may be configured to drive the electrically conductive member, for example. The electronic device may also include at least one other sensor carried by the housing, and the controller may be configured to cooperate with the at least one other sensor to determine whether the cover is in the closed position. The at least one other sensor may include an ambient light sensor, for example. The finger biometric sensor may include a capacitive finger biometric sensor.

A method aspect is directed to a method of selectively switching a display carried by a housing of an electronic device between a power saving mode and an operating power mode. The electronic device may include a finger biometric sensor carried by the housing and configured to sense an image of an object adjacent thereto. The method may also include using a controller coupled to the finger biometric sensor to determine when an electrically conductive member of a device cover is adjacent the finger biometric sensor, wherein the device cover is carried by the housing and configured to be movable between an open position exposing the finger biometric sensor and a closed position covering the finger biometric sensor, and wherein the device cover includes a cover panel carrying the electrically conductive member adjacent the finger biometric sensor when in the closed position. The method also includes using the controller to selectively switch the display between the power saving mode and the operating power mode based thereon.

### BRIEF DESCRIPTION OF THE DRAWINGS

FIG. 1 is a front perspective view of an electronic device according to an embodiment.

FIG. 2 is a schematic block diagram of the electronic device of FIG. 1.

FIG. 3 is a partially exploded side perspective view of the electronic device of FIG. 1 without the device cover.

FIG. 4 is a side schematic view of a portion of the electronic device of FIG. 1 including the finger biometric sensor.

FIG. 5 is a diagram of an exemplary pattern associated with the electrically conductive member of the electronic device of FIG. 1.

FIG. 6 is a diagram of the exemplary pattern of FIG. 5 overlaid on the finger biometric sensor, electrically conductive detection ring, and dielectric layer of the electronic device of FIG. 1.

FIG. 7 is a schematic block diagram of another embodiment of the electronic device of FIG. 1.

FIG. 8 is a schematic block diagram of another embodiment of the electronic device of FIG. 1 including an electrically conductive member.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

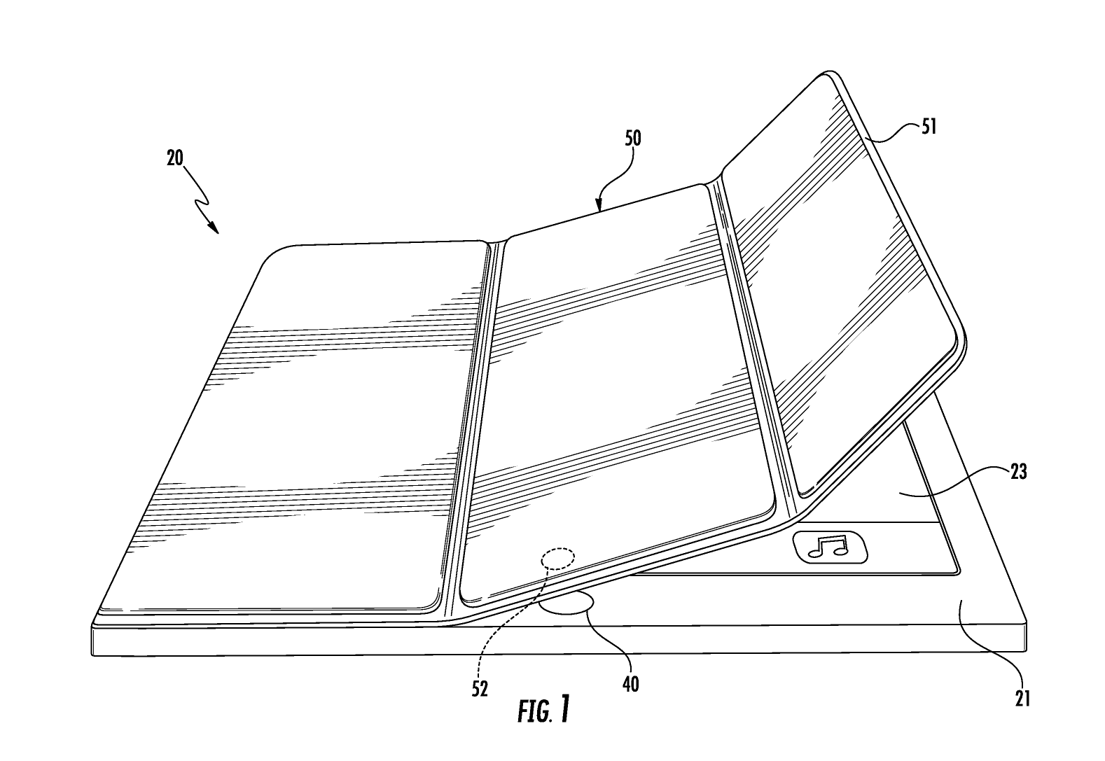

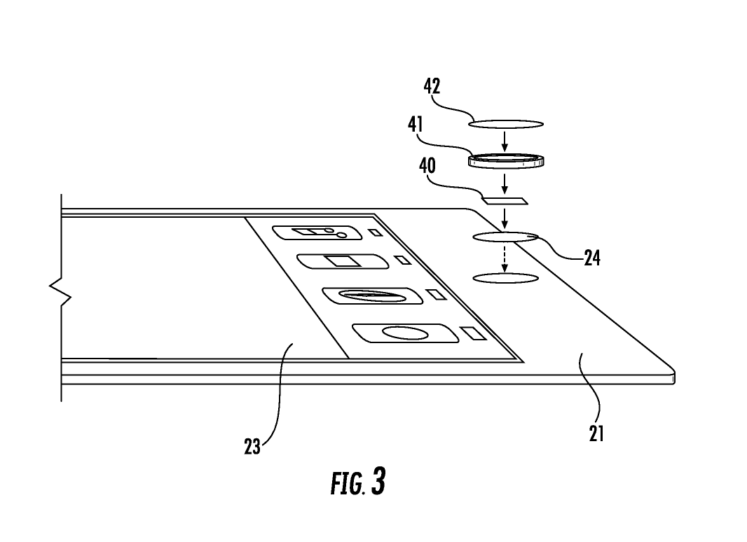

Referring initially to FIGS. 1-6 an electronic device 20 illustratively includes a housing 21 and a display 23 carried by the housing and coupled to a controller 22. The display 23 may be liquid crystal display (LCD), a light emitting diode (LED) display, or other type of display, for example. The display 23 may also be a touch display and may sense or be responsive to user input.

The electronic device 20 also includes wireless communications circuitry 25 carried by the housing 21 and coupled to the controller 22. The wireless communications circuitry 25 may be cellular, WiFi, Bluetooth, and/or other type of communications circuitry. The wireless communications circuitry 25 may cooperate with the controller 22 to perform a wireless communications function, for example. In some embodiments, the electronic device 20 may not include wireless communications circuitry 25. While the electronic device 20 is illustratively in the form of a mobile or smartphone, it will be appreciated that the electronic device may be a different type of electronic device, for example, a wearable device.

The electronic device 20 also includes a finger biometric sensor 40 carried by the housing 21. The finger biometric sensor 40 may be an integrated circuit that includes an array of finger biometric sensing pixels. The finger biometric sensor 40 senses an image of an object adjacent thereto. The finger biometric sensor 40 may be an electric field or capacitive finger biometric sensor, for example. The finger biometric sensor 40 cooperates with the controller 22 to perform any of an authentication function, a spoof detection function, and a navigation function, for example.

An input device 24 coupled to the controller 22 carries the finger biometric sensor 40. More particularly, the input device 24 is positioned below the finger biometric sensor 40. The input device 24 is illustratively in the form of a tactile switch. However, the input device 24 may be another type of input device. Other and/or additional input devices may be included.

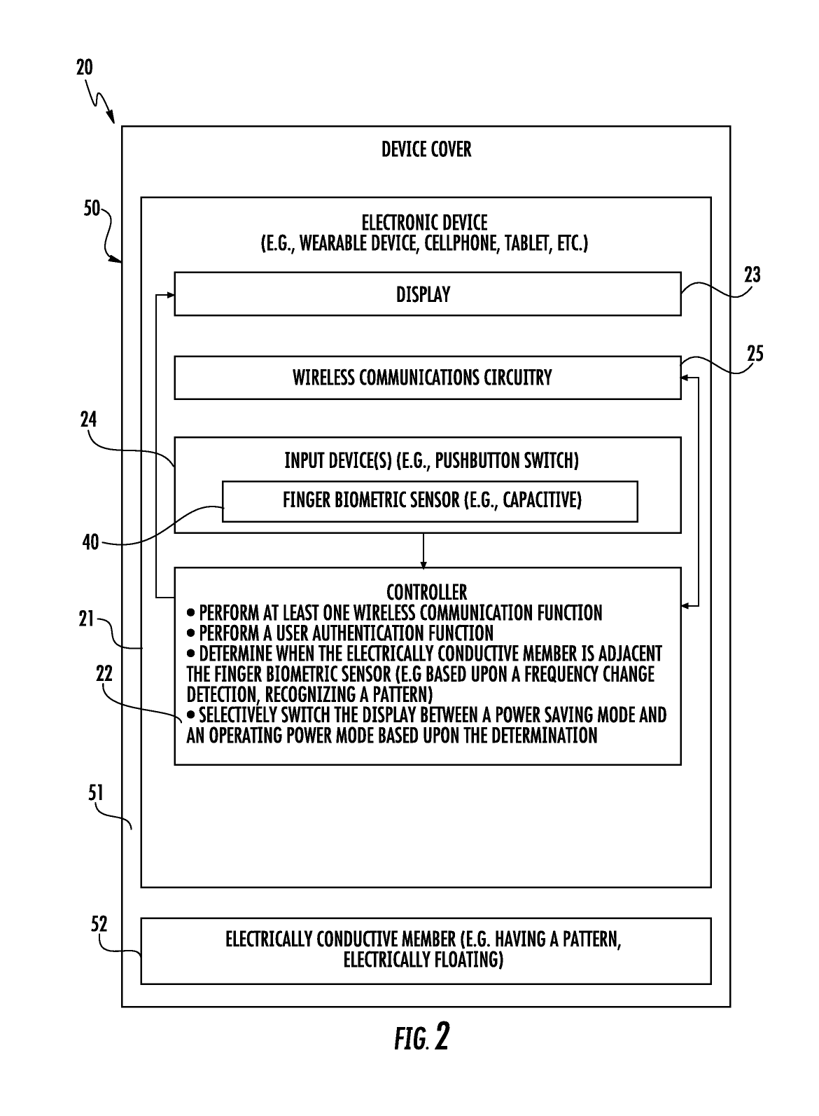

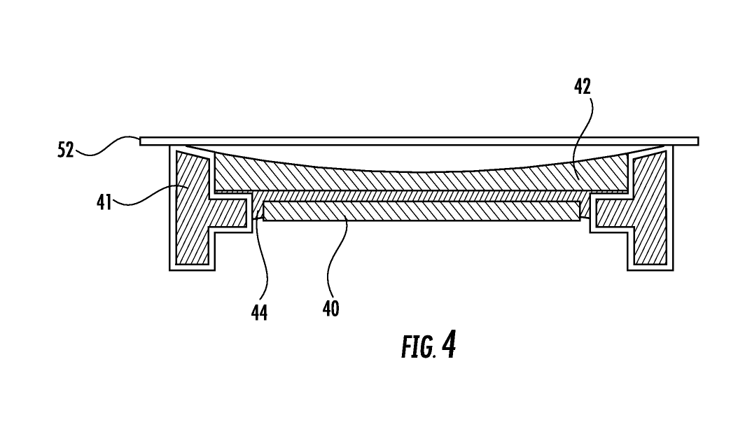

An electrically conductive detection ring 41 surrounds the finger biometric sensor 40 (FIGS. 2 and 4) and is coupled to the controller 22. The electrically conductive detection ring 41 may be stainless steel, for example. A dielectric layer 42 covers or is above the finger biometric sensor 40. The dielectric layer 42 may include sapphire, onyx, or other dielectric material, for example, and may be coupled in place via an encapsulation material 44 or layer.

Operation of the finger biometric sensor 40, for example, to sense an image adjacent thereto will now be described. The controller 22 may drive the electrically conductive detection ring 41 at a desired frequency. Presence of an object, for example, a finger, on the electrically conductive detection ring 41 causes additional capacitive loading on a finger-based frequency detection drive signal (e.g., generated by the controller 22), which, in turn, causes a frequency decrease.

Once a threshold has been exceeded (e.g., a sufficiently low frequency has been detected), the finger biometric sensor 40 cooperates with the controller 22 determining that an object (i.e., finger) is present and switches into an image-based frequency detection (IBFD) mode. In the IBFD mode, specific elements of the row and column capacitive sensor array, i.e., specific finger biometric sensing pixels, are selectively operated for determining presence of or acquiring an image. If, for example, a certain percentage of row and column elements indicate the presence of a finger, the finger biometric sensor switches to an imaging mode.

In the imaging mode, the finger biometric sensor 40 is operated to sense or acquire from all finger biometric sensing pixels. It should be noted that in some embodiments, not all finger biometric sensing pixels may be sensed, and finger biometric sensing pixels may be operated all different times, for example, sequentially and/or in subsets. The sensed or acquired image from the finger biometric sensor 40 is compared to stored fingerprint images, for example, stored in a memory.

If there is a match between the acquired image and the stored image (allowing for rotation and tilt), a corresponding signal may be communicated to the controller 22 or to a system processor, for example, to unlock the electronic device 20, unlock the display 23 of the electronic device, and/or perform another or additional device function. If there is not a match between the stored and acquired image or images, after a threshold number of failed attempts, the user may be prompted, via the display 23, to manually enter a passcode. It should be noted that the while a finger biometric sensor 40 and controller 22 have been described herein with respect to certain functions, the functions may be performed on one or both of the controller and the finger biometric sensor, and the finger biometric sensor and/or controller may include circuitry for performing other operations, as will be appreciated by those skilled in the art.

A device cover 50 is carried by the housing 21. The device cover 50 may be a protective and/or decorative cover for providing increased protection of the display 23, for example, against drops, scratches, and/or cracking. The cover 50 is movable between an open position exposing the finger biometric sensor 40 and a closed position covering the finger biometric sensor. The device cover 50 includes a cover panel 51 and an electrically conductive member 52 that is electrically floating and carried by the cover panel adjacent, for example, within 1 mm, the finger biometric sensor 40 when in the closed position. When in the open position, the cover panel 51 is physically spaced apart from the display 23 and the finger biometric sensor 40. Of course, the distance between the electrically conductive member 52 and the finger biometric sensor 40 may be different.

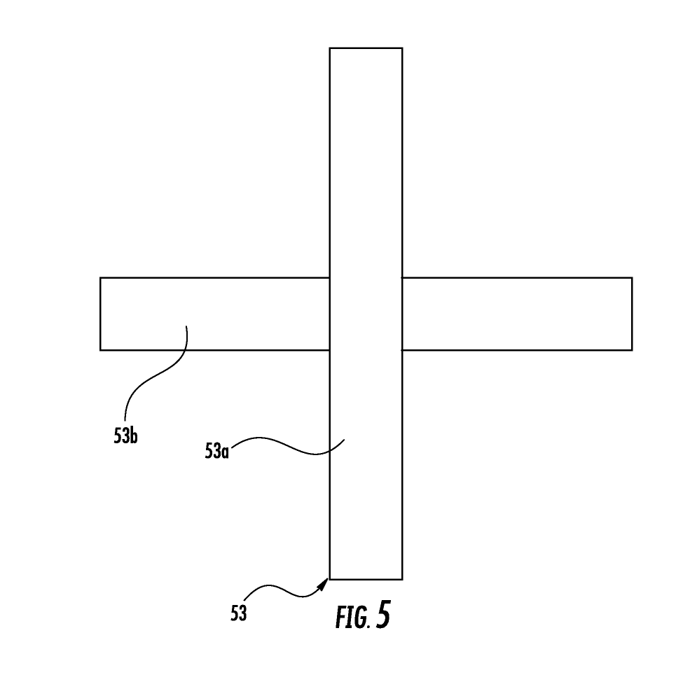

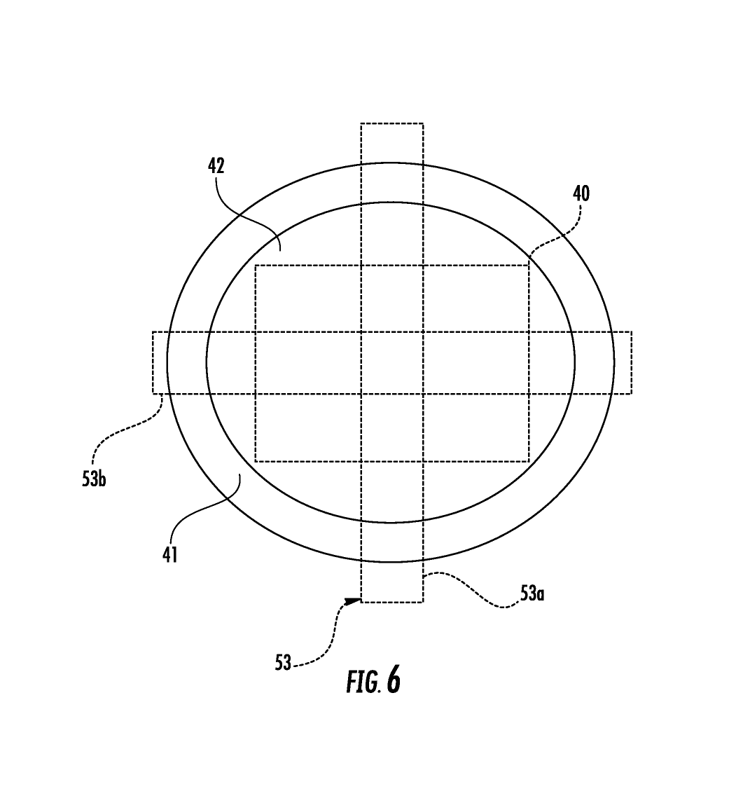

The electrically conductive member 52 illustratively has a pattern 53 of transverse elements 53a, 53b associated therewith (FIGS. 5 and 6). Of course, the electrically conductive member 52 may be associated with another pattern or shape.

The controller 22 determines when the electrically conductive member 52 is adjacent the finger biometric sensor, for example, based upon a detected change in frequency and based upon recognizing the pattern 53. The controller 22 selectively switches the display 23 between a power saving mode and an operating power mode based thereon. For example, in the power saving mode, the display 23 may be turned off or sufficiently powered down so that no graphics are displayed. Other functions of the electronic device 20 may be disabled or limited in functionality in the power saving mode, for example. In the operating power mode, the display 23 may be on and operating under full power. As will be appreciated by those skilled in the art, power, for example, battery power, may be conserved or power consumption reduced in the power saving mode. Moreover, the finger biometric sensor 40 may take the place of a dedicated Hall Effect sensor that is used to determine whether the cover is in the open or closed positions.

Further details will now be described with respect to the image acquisition modes of the finger biometric sensor 40 described above. In the frequency-based frequency detection (FBFD) mode, with the cover panel 51 closed, a distinct (non-fingerprint like) capacitive image, for example, corresponding to the pattern 53 associated with the electrically conductive member 52, is acquired based upon the electrically conductive member being overlaid on the dielectric layer 42 and electrically conductive detection ring 41. Of course, the pattern 53 may be a different pattern, but it is generally desirable that the pattern be distinct from a fingertip/fingerprint image or a blurred fingertip/fingerprint image. The acquired image generally extends across the electrically conductive detection ring 41 and dielectric layer 42 so that the finger biometric sensor 40 operating in the FBFD mode has the additional capacitance present to shift the frequency low enough to cause the finger biometric sensor to switch between the FBFD mode and the IBFD mode.

In the IBFD mode of the finger biometric sensor 40, the acquired image generally must be easily discernible from an actual fingerprint image. For example, relatively larger finger biometric features with sharp edges may be used for discerning the difference between the cover panel 51 being in the closed position and a user attempt to unlock the electronic device 20 with a finger. An acquired image or images in the IBFD mode, for example, of the cover panel 51 are compared, for example, via cooperation with the controller 22, against enrolled images of the cover panel. If the controller 22 determines there is a match between the enrolled images of the cover panel 51 and the acquired images, the finger biometric sensor 40 cooperates with the controller 22 to switch the display 23 to the power saving mode. In some embodiments, the controller 22 may cooperate with an upstream system processor to send an encoded message to switch to the power saving mode. In other embodiments, the controller 22 may be itself or part of the system processor.

If the controller 22 determines comparison does not match the pre-programmed capacitive cover image loaded at the Module integrator, the image there is not a match between the enrolled images of the cover panel 51 and the acquired images, the finger biometric sensor 40 cooperates with the controller 22 to compare the acquired images with the enrolled finger images. If the acquired image matches an enrolled finger, the finger biometric sensor 40 moves into an imaging mode, as will be appreciated by those skilled in the art. If the acquired image does not match the enrolled finger, the finger biometric sensor 40 performs a “reset” and is switched to the FBFD mode.

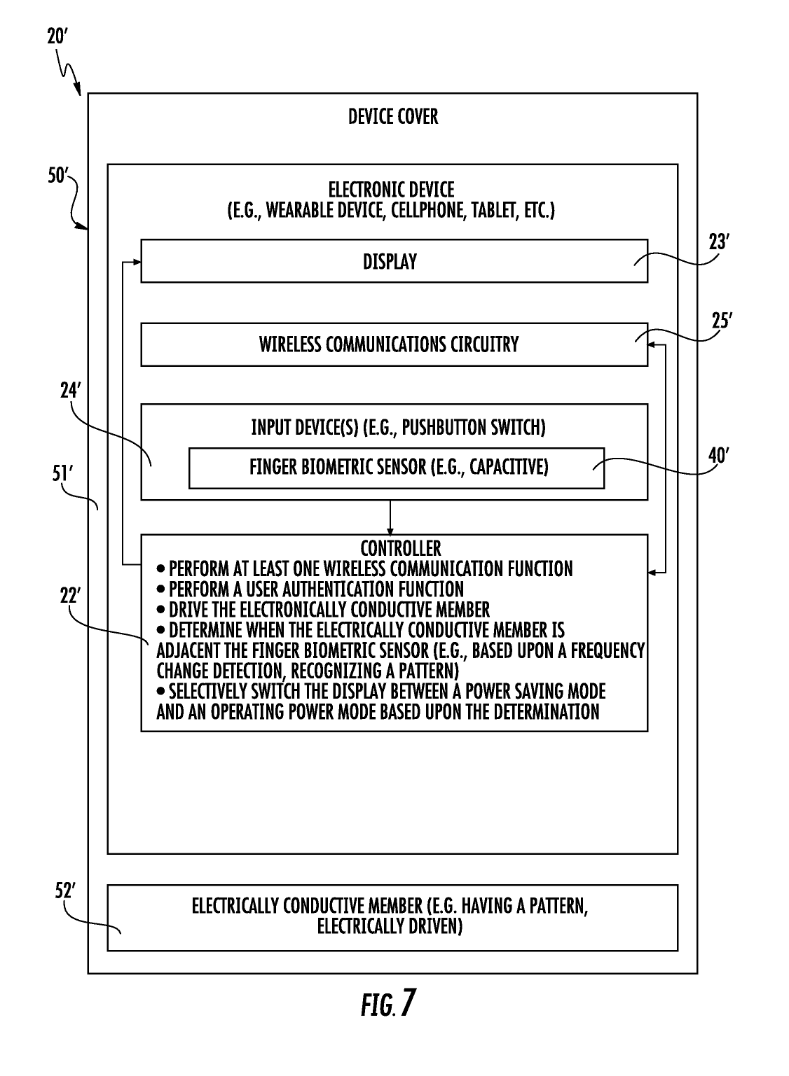

Referring briefly to FIG. 7, in another embodiment, the controller 22′ may configured to drive the electrically conductive member 52′. In this embodiment, the device cover 50′ may be considered a smart cover wherein an electrical interface exists between the electronic device 20′ and the device cover (e.g., via a connector) which can be used to drive the finger biometric sensor 40′ via the electrically conductive member 52′, for example, the acquired image, to a known charge state, so that a drive signal is transmitted from or emanates from the device cover 50′. This drive signal is generally discernible in the FBFD mode (i.e., effectively frequency modulating the FBFD sense signal).

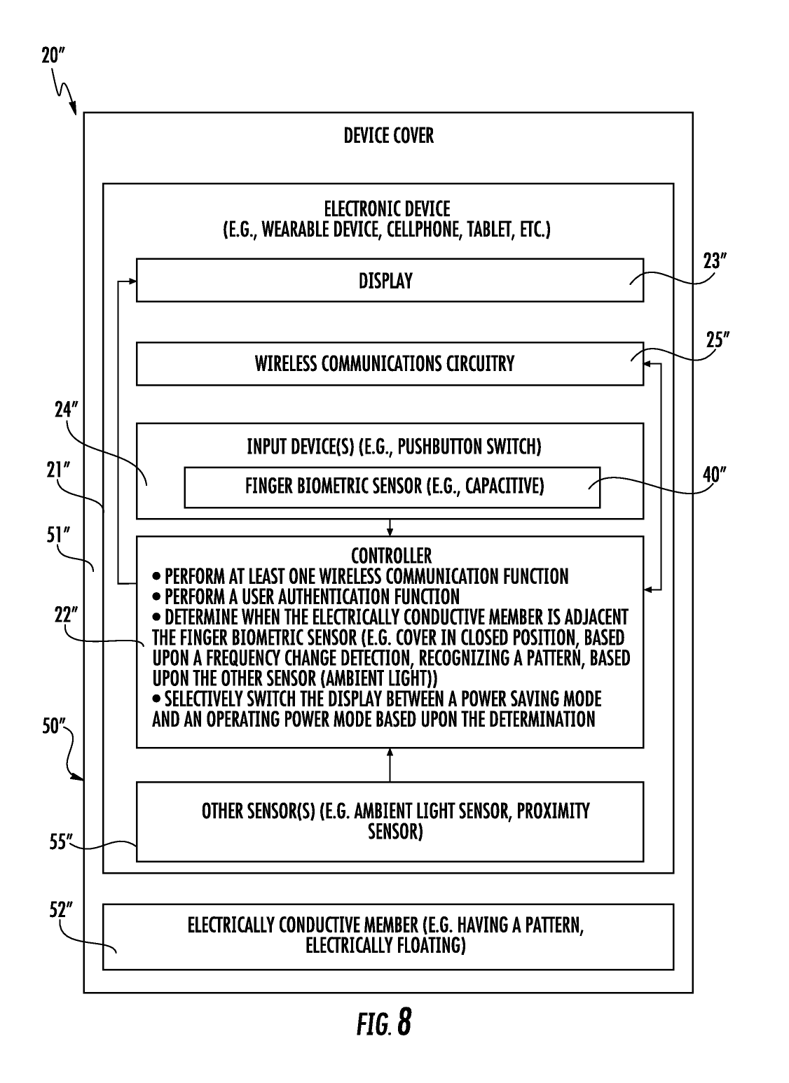

Referring now to FIG. 8, at least one other sensor, for example, an ambient light sensor 55″ is carried by the housing 21″. The controller may cooperate with the ambient light sensor 55″ to determine whether the cover 50″ is in the closed position. This may address jostling or movement of the cover panel 51″ that may improperly switch the display 23″ to the power saving mode. More than one other sensor 55″ may be used, and a sensor of a different type may also be used. For example, a proximity sensor and/or another finger biometric sensor may be used.

For example, the electronic device 20″ (with the cover panel 51″ in the closed position) may be carried in a backpack or a user's pocket and could experience movement based on the dynamic environment present). It should be noted that the “jostling” issue may not be a concern for a smart cover, as described above, as a smart cover may frequency modulate the FBFD and assist in discerning whether the cover panel 51″ and more particularly, the electrically conductive member 52″ is adjacent the finger biometric sensor 40″, effectively reducing concerns with cover movement on smart covers.

Thus, it may be desirable that the acquired image fully cover the dielectric layer and the electrically conductive detection ring despite dynamic movement of the cover panel 51″. To address this, a tolerance analysis and/or user studies may be performed to determine how much positional variation (for example, in the X and Y, and/or Z axes) could be reasonably expected. The acquired image dimensions may then be set accordingly to compensate for this variability. A polling routine may also be implemented, for example, via the controller 22″ (e.g., with temporal controls), that limits the number of IBFD events that could occur per unit time so that battery power may not be impacted with device cover 50″ movement.

A method aspect is directed to a method of selectively switching a display 23 carried by a housing 21 of an electronic device 20 between a power saving mode and an operating power mode. The electronic device 20 includes a finger biometric sensor 40 carried by the housing 21 and configured to sense an image of an object adjacent thereto. The method includes using a controller 22 coupled to the finger biometric sensor 40 to determine when an electrically conductive member 52 of a device cover 50 is adjacent the finger biometric sensor 40. The device cover 50 is carried by the housing 21 and configured to be movable between an open position exposing the finger biometric sensor 40 and a closed position covering the finger biometric sensor, and the device cover includes a cover panel 51 carrying the electrically conductive member 52 adjacent the finger biometric sensor when in the closed position. The method also includes using the controller 22 to selectively switch the display 23 between a power saving mode and an operating power mode based thereon.

The present disclosure recognizes that personal information data, including biometric data, in the present technology, can be used to the benefit of users. For example, the use of biometric authentication data can be used for convenient access to device features without the use of passwords. In other examples, user biometric data is collected for providing users with feedback about their health or fitness levels. Further, other uses for personal information data, including biometric data, that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure, including the use of data encryption and security methods that meets or exceeds industry or government standards. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data, including biometric data, and further contemplates user restrictions on storing data in cloud-based services and/or restricting access to the same. That is, the present disclosure contemplates that hardware and/or software elements can be provided to prevent or block access to such personal information data. For example, in the case of biometric authentication methods, the present technology can be configured to allow users to optionally bypass biometric authentication steps by providing secure information such as passwords, personal identification numbers (PINS), touch gestures, or other authentication methods, alone or in combination, known to those of skill in the art. In another example, users can select to remove, disable, or restrict access to certain health-related applications collecting users' personal health or fitness data.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An electronic device comprising:
a housing;
a display carried by the housing and switchable between a power saving mode and an operating power mode;
a finger biometric sensor carried by the housing and configured to sense an image of an object adjacent thereto;
a device cover carried by the housing and configured to be movable between an open position exposing the finger biometric sensor and a closed position covering the finger biometric sensor, the device cover comprising a cover panel and an electrically conductive member carried by the cover panel adjacent the finger biometric sensor when in the closed position; and
a controller coupled to the finger biometric sensor and configured to determine when the electrically conductive member is adjacent the finger biometric sensor, and selectively switch the display between the power saving mode and the operating power mode based thereon.

2. The electronic device of claim 1 wherein the controller is configured to determine when the electrically conductive member is adjacent the finger biometric sensor based upon a frequency change detection.

3. The electronic device of claim 1 wherein the electrically conductive member has a pattern associated therewith; and wherein the controller is configured to enter the power saving mode based upon recognizing the pattern.

4. The electronic device of claim 3 wherein the pattern comprises a plurality of transverse elements.

5. The electronic device of claim 1 wherein the electrically conductive member is electrically floating.

6. The electronic device of claim 1 wherein the controller is configured to drive the electrically conductive member.

7. The electronic device of claim 1 further comprising at least one other sensor carried by the housing; and wherein the controller is configured to cooperate with the at least one other sensor to determine whether the cover is in the closed position.

8. The electronic device of claim 7 wherein the at least one other sensor comprises an ambient light sensor.

9. The electronic device of claim 1 wherein the finger biometric sensor comprises a capacitive finger biometric sensor.

10. An electronic device to be operable with a device cover movable between an open position and a closed position, the device cover comprising a cover panel and an electrically conductive member carried by the cover panel, the electronic device comprising:
a housing carrying the device cover;
a display carried by the housing and switchable between a power saving mode and an operating power mode;
a finger biometric sensor carried by the housing adjacent the electrically conductive member when in the closed position, the finger biometric sensor being configured to sense an image of an object adjacent thereto, and the finger biometric sensor being exposed when the device cover is in the open position and covered when the device cover is in the closed position; and
a controller coupled to the finger biometric sensor and configured to determine when the electrically conductive member is adjacent the finger biometric sensor, and selectively switch the display between the power saving mode and the operating power mode based thereon.

11. The electronic device of claim 10 wherein the controller is configured to determine when the electrically conductive member is adjacent the finger biometric sensor based upon a frequency change detection.

12. The electronic device of claim 10 wherein the electrically conductive member has a pattern associated therewith; and wherein the controller is configured to enter the power saving mode based upon recognizing the pattern.

13. The electronic device of claim 12 wherein the pattern comprises a plurality of transverse elements.

14. The electronic device of claim 10 wherein the electrically conductive member is electrically floating.

15. The electronic device of claim 10 wherein the controller is configured to drive the electrically conductive member.

16. The electronic device of claim 10 further comprising at least one other sensor carried by the housing; and wherein the controller is configured to cooperate with the at least one other sensor to determine whether the cover is in the closed position.

17. A method of selectively switching a display carried by a housing of an electronic, device between a power saving mode and an operating power mode, the electronic device comprising a finger biometric sensor carried by the housing and configured to sense an image of an object adjacent thereto, the method comprising:
using a controller coupled to the finger biometric sensor to
determine when an electrically conductive member of a device cover is adjacent the finger biometric sensor, the device cover being carried by the housing and configured to be movable between an open position exposing the finger biometric sensor and a closed position covering the finger biometric sensor, the device cover comprising a cover panel carrying the electrically conductive member adjacent the finger biometric sensor when in the closed position, and
selectively switch the display between the power saving mode and the operating power mode based thereon.

18. The method of claim 17 wherein the controller is used to determine when the electrically conductive member is adjacent the finger biometric sensor based upon a frequency change detection.

19. The method of claim 17 wherein the electrically conductive member has a pattern associated therewith; and wherein the controller enters the power saving mode based upon recognizing the pattern.

20. The method of claim 19 wherein the pattern comprises a plurality of transverse elements.

21. The method of claim 17 wherein the electronic device further comprises at least one other sensor carried by the housing; and wherein the controller is used to cooperate with the at least one other sensor to determine whether the cover is in the closed position.
